(19) United States
(12) Patent Application Publication
(10) Pub. No.: US 2007/0061780 A1
(43) Pub. Date: Mar. 15, 2007

(54) Enterprise resource planning system test framework

(75) Inventors: David Pokluda, Vaerloese (DK); Elizabeth Kim Alexander, Kirkland, WA (US); Fabricio Noriega, Frederiksberg (DK); Liviu Daniel Olaru, Copenhagen (DK); Olga Gerasimova, Virum (DK); Rune Hakansson, Gentofte (DK)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/215,799

(22) Filed: Aug. 29, 2005

(51) Int. Cl. G06F 9/44

(52) U.S. Cl. 717/124

(57) ABSTRACT

A method of testing a business application in an enterprise resource planning (ERP) system is provided. The business application is written using an application program interface (API) of the ERP system. The method comprises providing a test package configured to control testing of the business application. The method further comprises testing logic of the business application under the test package control using the same API of the ERP system which was used to create the business application.

### BACKGROUND

The discussion below is merely provided for general background information and is not intended to be used as an aid in determining the scope of the claimed subject matter.

Enterprise resource planning (or ERP) is a phrase used to describe a broad set of activities supported by multi-module application software that helps a manufacturer or other business manage the important parts of its business, including product planning, parts purchasing, maintaining inventories, order tracking, interacting with suppliers, providing customer service, finance, human resources, etc. An example of an ERP system is Microsoft® Business Solutions-Axapta®. Axapta® provides functionality to support many needs of a business, for example including: manufacturing; distribution, supply chain management, project management, financial management, human resource management, business analysis, enterprise portal, commerce gateway, etc.

ERP systems provide a platform upon which business applications can be built. A business application in an ERP system commonly utilizes forms that are displayed to the users of the business application, and the user interacts with the application through these forms. Typically, these forms are the primary interface between the user and the business application. Testing the business application logic of these forms, or of other functions of the business application, is necessary before sale or deployment of the application.

Typically, to build a business application, developers use an application program interface (API) designed specifically for the particular ERP system. For example, in Microsoft® Business Solutions-Axapta®, an Axapta® object model or API is available for use by business application developers. In the case of Axapta®, the object model or API is based upon the X++programming language. Other ERP systems and their corresponding API's can be based on other programming languages. Often, as in the case with the Axapta® API, developers can be trained and certified in the use of the ERP system API.

The ERP API is the interface that the ERP system provides to application developers, handling function calls between the business application and the ERP system. Typically, an API includes a set of many (often thousands) detailed functions and subroutines that programmers can use, which cause the ERP to take corresponding actions. For example, the ERP system API typically offers multiple user interface (UI) elements that are used to build the application UI. Unfortunately these UI elements are generally not common operating system (OS) controls, but rather are custom controls for the particular ERP system.

Some ERP systems are not dependent upon particular hardware or a particular OS, but rather can be run on differing hardware and OS's. This is one reason that ERP systems are often not designed to rely on standard OS UI controls or APIs. On the other hand, ERP developers and business application developers frequently don't want to customize their code for every supported platform. Instead, ERP systems publish their own UI controls and API that is shared across all platforms. As a result, if standard UI test automation tools are used, they will frequently not work because ERP UI controls are not standard OS UI controls. Also, the API is often not a standard OS API (e.g., a standard OS API like Win32 API in Windows® OS). On the other hand it can be beneficial to give application developers pretty much the same possibilities and flexibility they would have with a standard OS API. As a result, ERP API's are often quite large, including thousands of methods and subroutines as mentioned above.

These factors present challenges when automating tests of ERP applications through the UI. For example, grid control which presents data in a table-like format, when viewed from outside, is just one graphic control where all the records and columns are rendered as graphics. Automating such controls presents a challenge, especially in ERP systems where grids are the most common controls. As a result, common operating system UI test frameworks are of limited value for this purpose. In addition to the limited value of existing operating system test frameworks to test ERP business logic, third party test software is similarly of limited value for the same reasons, namely the custom controls used in the ERP system. Lacking the ability to easily use any of these conventional testing software packages, testing of ERP system business applications can be a cumbersome task.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Disclosed embodiments include methods, apparatus and/or systems which test logic in a business application of an ERP system. The embodiments use the same application program interface (API), which was used to create the business application, to test the business application.

### BRIEF DESCRIPTION OF THE DRAWINGS

FIG. 1 is a block diagram of a general computing environment in which disclosed concepts can be practiced.

FIG. 2 is a block diagram illustrating an embodiment of an enterprise resource planning (ERP) application test system.

FIG. 3 is a diagrammatic illustration of a form class generator.

FIGS. 4 and 5 are flow diagrams illustrating method embodiments.

### DETAILED DESCRIPTION

Disclosed embodiments include methods, apparatus and systems which test business application logic in enterprise resource planning (ERP) systems. Customized business application logic in ERP systems is built using custom user interface (UI) controls of the ERP system. Therefore, traditional tools used in test automation (3 rd party software, standard operating system UI tools, etc.) aren't generally used. Most ERP systems have their own application program interfaces (API's) used by partners to build custom solutions on top of the ERP platform. Disclosed embodiments use these API's to build a test automation framework to test the ERP business application logic, not from outside the system but, from inside the system using the API. The framework for writing automated tests is built using the application object model or API. The purpose of the framework is to provide a set of classes targeted to test case script developers. These classes emphasize some of the native API's and hide the rest of the API complexity. This gives the developer tools and classes with the most common methods used during test case scripting.

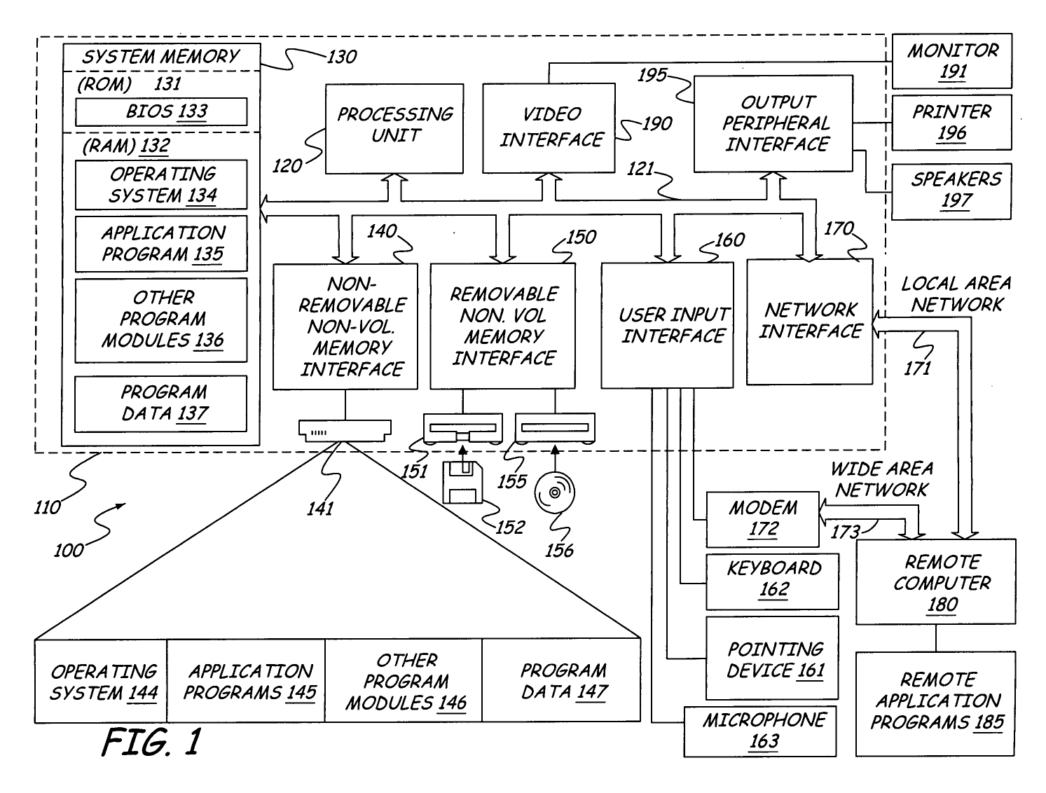

The disclosed methods; apparatus and systems can be embodied in a variety of computing environments, including personal computers, server computers, etc. In particular, the disclosed embodiments can be implemented in any computing environment associated with the development, testing or operation of ERP systems and/or business applications for ERP systems. Before describing the embodiments in greater detail, a discussion of an example computing environment in which the embodiments can be implemented may be useful. FIG. 1 illustrates one such computing environment.

FIG. 1 illustrates an example of a suitable computing system environment 100 on which one or more aspects of the illustrated embodiments may be implemented. The computing system environment 100 is only one example of a suitable computing environment and is not intended to suggest any limitation as to the scope of use or functionality of the illustrated embodiments. Neither should the computing environment 100 be interpreted as having any dependency or requirement relating to any one or combination of components illustrated in the exemplary operating environment 100.

The illustrated embodiments are operational with numerous other general purpose or special purpose computing system environments or configurations. Examples of well-known computing systems, environments, and/or configurations that may be suitable for use with the illustrated embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The illustrated embodiments may be described in the general context of computer-executable instructions, such as program modules, being executed by a computer. Generally, program modules include routines, programs, objects, components, data structures, etc. that perform particular tasks or implement particular abstract data types. The illustrated embodiments may also be practiced in distributed computing environments where tasks are performed by remote processing devices that are linked through a communication network. In a distributed computing environment, program modules may be located in both local and remote computer storage media including memory storage devices. Tasks performed by the programs and modules are described below and with the aid of figures. Those skilled in the art can implement the description and figures provided herein as processor executable instructions, which can be written on any form of a computer readable medium.

With reference to FIG. 1, an exemplary system includes a general-purpose computing device in the form of a computer 110. Components of computer 110 may include, but are not limited to, a processing unit 120, a system memory 130, and a system bus 121 that couples various system components including the system memory to the processing unit. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150. Interfaces 140 and 150 can be the same API's.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, Intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

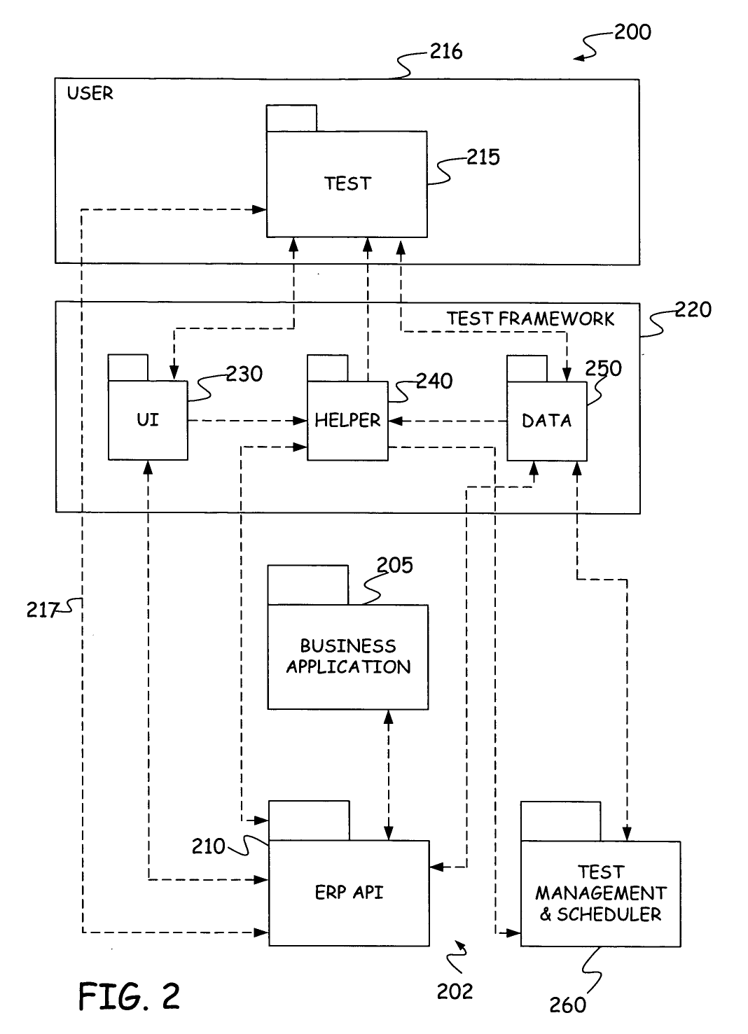

Referring now to FIG. 2, shown is an ERP application test system 200 for testing a business application 205. As is understood in the art, a business application 205 used in an ERP system is created using an API 210 of the ERP system (ERP system represented generally at 202). Application developers use the API 210 to provide an interface to custom controls available through the ERP system. In accordance with disclosed embodiments, instead of using 3^{rd} party software or other traditional automation tools to test the logic of business application 205, API 210 of the ERP system is used to test the application.

In various embodiments, different packages can run on different computers, for example a server computer and a client computer. For example, in some embodiments, a majority of the code runs on the client computer, but this need not be the case. In some exemplary embodiments, the ERP API runs on both the server and the client machines. Similarly, in some exemplary embodiments, the business application runs on the server, and only the presentation layer (e.g., forms) are running on the client. A test package 215 interacts with the business application through the presentation layer and thus it runs on the client machine. Because of that fact, most of (if not all) of the test automation framework will typically also run on the client machine. The present embodiments are not limited to any specific division of software or code between the server and client computers.

In FIG. 2, API 210 is illustrated interfaced with business application 205 for testing purposes. A test package 215, on a client's computer 216, optionally interfaces (as shown at 217) directly with API 210 to control the testing process. This is one possible embodiment which uses the methods of the API, also used to create business application 205, to test the business application. However, direct interface 217 need not be used in all embodiments, as will be described below in greater detail. Test package 215 will typically be written by a software test engineer (STE) or others for the purpose of automating the test of application 205, controlling which UI controls and other logic are tested, the order of testing, the data used in the tests, etc. Under the control of test package 215, the logic of business application 205 can be tested by calling the methods and subroutines available in the ERP system through API 210. One reason why STE's might not write test scripts using the ERP API 210 directly is that there are typically different requirements for a test automation API then there are for an ERP API. Because of that, ERP API 210 may not be ideally suited for test automation. In this case, STE's can take advantage of a special API provided in the form of test framework 220.

Test case management and scheduler component or module 260 is optionally included in some embodiments to control scheduling of times for automations. Module 260 is also used for reporting. When the test case is executed, all the test results can be uploaded into this module and the results can be browsed from there. Also, in some embodiments, managers can use this module to create reports from test results across all available tests.

Although test package 215 can in some embodiments directly interface with API 210, in other embodiments, this interface occurs through test framework 220. Test framework 220 can reside on the user's computer 216, on an ERP system server, or elsewhere. Like API 210, test framework 220 can be considered to be part of the ERP system 202, or it can be separate. Test framework 220 is designed for use in writing automated tests, such as represented by test package 215. In some embodiments, test framework 220 itself is built using the ERP system API 210. The purpose of the framework is to provide a set or library of classes targeted to test case script developers. Besides a set of classes the framework can include additional tools (external applications) that are to provide additional functionality not present in the ERP API. The classes allow a test script developer to create a script through which the business application is controlled using API 210. These classes emphasize some of the native API, and hide the rest of the API complexity. This gives the developer tools and classes with the most common methods used during test case scripting.

In object-oriented programming, a class comprises a collection of types of encapsulated instance variables and types of methods, possibly with implementation of those types together with a constructor function that can be used to create objects of the class. A class is a cohesive package that consists of a particular kind of compile-time metadata. A Class describes the rules by which objects behave; these objects are referred to as “instances” of that class. A class specifies the structure of data which each instance contains as well as the methods (functions) which manipulate the data of the object; such methods are sometimes described as “behavior”. A method is function with a special property that it has access to data stored in an object. A class is the most specific type of an object in relation to a specific layer. A class may also have a representation (metaobject) at run-time, which provides run-time support for manipulating the class-related metadata.

Instances of a class will have certain aspects in common. For example, a class Control would describe the properties common to all instances of the Control class. One of the benefits of programming with classes is that all instances of a particular class will follow the defined behavior of said class. Each control is generally alike; but varies in such properties as “name” and “position”. The class would list types of such instance variables; and also define, via methods, the actions which controls can perform: “enable”, “set focus”, “get value”, “validate content”, etc.

In some embodiments, the classes provided in test framework 220 are divided into three groups, UI classes, Data classes, and Helper classes.

UI Classes

The first group of classes, labeled UI 230, focuses on UI elements of the ERP system. This group of classes is responsible for handling forms, controls, reports, and all other UI elements of the ERP system. In example embodiments, for every UI element type there can be a specific class dealing with this type of element. There is in an example embodiment a class dealing with ERP forms, a class dealing with reports, and a general class dealing with controls. Because ERP systems offer a wide range of different UI controls, it is sometimes not sufficient to have just one class dealing with all these control types. For this reason, the framework 220 contains a special class for every available control type. To make the test framework API more intuitive and usable, there is a class hierarchy that enables control classes to share common functionality across multiple classes (this also helps test script developers to learn and use the framework).

To even more simplify automation of ERP forms, it is possible to add a “form class” generator into the test automation framework. This form class generator then generates a form class for all specified ERP forms. These form classes are than capable of handling all aspects of that particular form (including all the controls positioned on that form).

Different types of UI classes in an example embodiment are described as follows. These are provided as examples only, and disclosed embodiments are not limited to these specific types of UI classes.

Forms

Typically, ERP forms are not just screens for entering, validating and editing data. To users of the application, the forms are the application, because they make up most of the application's user interface. Therefore the forms are an important way for users to interact with the application. By interacting with the forms, users control the flow of the application.

Controls

Form controls are used to add layout or functionality to forms. Forms usually contain multiple controls that users use to communicate with the application. In an example embodiment, all ERP system controls can be derived from a class referred to here as “FormControl” class. This class provides basic functionality for all ERP system controls.

In an ERP system such as Axapta®, there is not a deep hierarchy of control classes. Instead, they are all derived directly from FormControl class. Therefore, there are no strict commonalities. In some embodiments, test framework 220 introduces a deeper hierarchy of classes (e.g., classes organized and nested in a tree structure in some examples), allowing the test framework to provide basic functionality that is reused by all derived classes. From the test developer's point of view the advantage is that related controls (all string value controls, for example) have the same functionality.

Form Classes

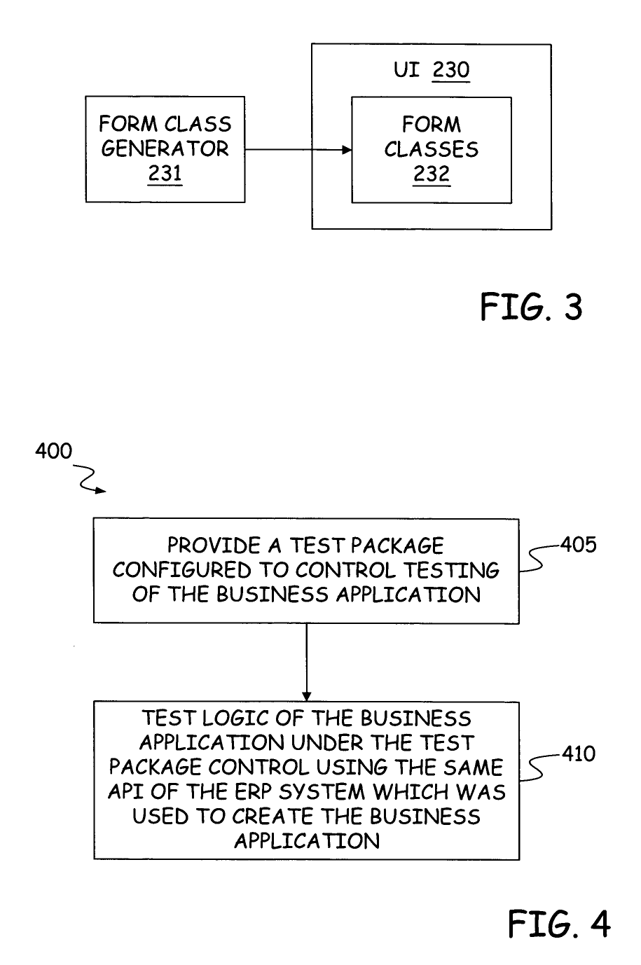

If a form contains many (for example, hundreds) of controls, instantiating all form classes and control classes can be tedious. A form class generator 231 shown in FIG. 3 can be included in test framework 220 and used in these situations to generate form classes 232 for ERP system forms. A generated class 232 contains a variable for every control on the corresponding ERP system form. In these embodiments, the tester writes test code accessing the real ERP system form and all its controls through the generated form class.

Data Classes

Referring again to FIG. 2, the second group of classes, labeled data 250, is responsible for data handling. In this group are classes for accessing test case data as well as dealing with test case prerequisite data and other test case data.

The classes in this group of the framework are also capable of comparing test result data with a baseline, etc. Data class 250 handles data requirements in all phases of test automation. One of the basic requirements for test automation is test repeatability. To meet this requirement, it is always necessary to run the test on the same base data with the same data inputs. When the test is finished, it should return the same results, assuming that it has passed.

In some embodiments, an automated test begins by importing base data into the ERP system. This is controlled by data classes 250. Then when the test runs, user input values are provided from an external data value file. This allows the same test to be run with a different dataset without anyone touching the test code. At the end of the test (or after a major step within the test), the ERP system data is validated and compared to a baseline. Data classes 250 can be used to implement these tasks as well.

Prerequisite Data

Usually at the beginning of the test case it is important to ensure that all data necessary for the test case is loaded and consistent. In some embodiments, data classes 250 of test framework 220 include a class to serve this purpose.

With the class it is possible to load binary data files, text data files, as well as XML files. Sometimes multiple feature teams share common base data. Then it is possible either to import the whole data or to specify just a subset of the data to be imported.

Test Case Data

Test case data is information that is normally entered into the form(s) by testers as a part of the test. In an automated test case, this data can either be directly entered into the test case code or to be stored in a separate file. In data classes 250 of test framework 220, data can be stored in a separate file in some embodiments, making it easy to modify just the data without modifying the test case code. In exemplary embodiments, test case data are in XML format, and can contain multiple sets of data for a particular test case. These sets of data are referred to here as datasets. It is possible to run a test with different datasets or with all available datasets for that test case without changing the test case code. Support for this functionality is directly in the test automation framework.

Result Data and Comparisons

At the end of a test case, result data can be exported or compared to a baseline using data classes.

Helper Classes

Referring again to FIG. 2, shown at 240 is the third group of classes, referred to as helper classes. These are additional classes that help testers with test automation. Classes in this group are responsible for every other aspect of test automation. This includes logging, result reporting, interaction with external tools and components (e.g., test harness and test case management system). This part can also contain general classes of the framework. An example of such a general class can be a class for storing global parameters or for configuring test framework or test environment in the ERP. Classes in this group can be extremely important. Without a logger class (responsible for propagating information from test case into test result repository) any control validation would typically not make sense because the information about validation result would not appear anywhere.

As was already mentioned, the framework 220 covers all UI elements. There are situations though when an ERP object model or API may not provide full functionality in the framework. In these situations, external tools can be relied upon to provide this additional functionality. Therefore the framework actually combines the two approaches (testing from inside and testing using external tools) into a one set of tools.

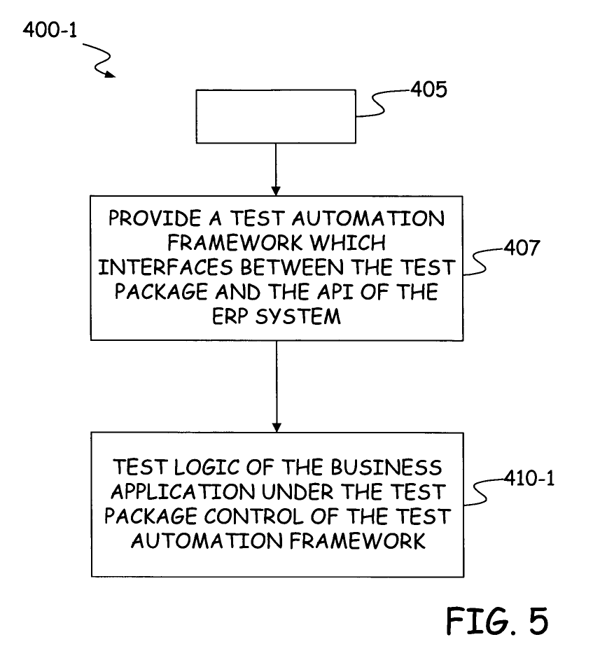

Disclosed methods have been described with reference to the operation of system 200 shown in FIG. 2. FIGS. 4 and 5 are flow diagrams illustrating first and second embodiments of these methods. As shown in flow diagram 400 included in FIG. 4, a method of testing a business application in an ERP system comprises step 405 of providing a test package 215 configured to control testing of the business application 205. The method further comprises the step 410 of testing logic of the business application under the test package control using the same API 210 of the ERP system 202 which was used to create the business application.

Shown in FIG. 5 is a flow diagram 400-1 which illustrates a more particular embodiment of the method. In this embodiment, test package 215 interfaces with API 210 through test automation framework 220 as was described above. As such, after step 405 from FIG. 4, the method shown in FIG. 5 includes the step 407 of providing a test automation framework which interfaces between the test package and the API of the ERP system. In various embodiments of step 407, this includes providing the test framework 220 with some or all of the classes illustrated in FIG. 2 and described above. After step 407, step 410 from FIG. 4 is modified in the method shown in FIG. 5 to include testing logic of the business application under the test package control of the test automation framework 220.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of testing a business application in an enterprise resource planning (ERP) system, the business application being written using an application program interface (API) of the ERP system, the method comprising:
providing a test package configured to control testing of the business application; and
testing logic of the business application under the test package control using the same API of the ERP system which was used to create the business application.

2. The method of claim 1, and further comprising:
providing a test automation framework which interfaces between the test package and the API of the ERP system; and
wherein testing logic of the business application further comprises testing logic of the business application under the test package control of the test automation framework.

3. The method of claim 2, wherein providing the test automation framework further comprises providing a test automation framework generated with the same API of the ERP system which was used to create the business application.

4. The method of claim 2, wherein providing the test automation framework further comprises providing a plurality of classes which can be used to create a script through which the business application is controlled using the API.

5. The method of claim 4, wherein providing the plurality of classes further comprises providing a set of user interface classes configured to wrap to ERP system user interface elements through the API.

6. The method of claim 5, wherein providing the set of user interface classes further comprises providing a control class configured to wrap to ERP system user interface controls through the API.

7. The method of claim 5, wherein providing the set of user interface classes further comprises providing a form class, wherein an instance of the form class contains a plurality of variables for controls on a corresponding ERP system form.

8. The method of claim 4, wherein providing the plurality of classes further comprises providing a set of data classes which handle data while testing logic of the business application.

9. A computer-readable medium having stored thereon computer-executable instructions for performing the steps of method claim 1.

10. An ERP application test system configured to perform the steps of method claim 1.

11. The ERP application test system of claim 10, wherein being configured to perform the steps of method claim 1 further comprises data handling using a test automation framework which interfaces between the test package and the API of the ERP system.

12. The ERP application test system of claim 11, wherein being configured to perform the steps of method claim 1 further comprises test results handling using the test automation framework which interfaces between the test package and the API of the ERP system.

13. An enterprise resource planning (ERP) application test system for testing a business application, the application test system comprising:
an application program interface (API) of the ERP system interfaced with the business application, wherein the API of the ERP system is a same API used to create the business application; and
a test package interfaced with the API of the ERP system and configured to control testing of the business application using the API of the ERP system.

14. The ERP application test system of claim 13, and further comprising:
a test automation framework which provides the interface between the test package and the API of the ERP system, wherein the test package is configured to control testing of the business application by controlling the test automation framework.

15. The ERP application test system of claim 14, wherein the test automation framework comprises sets of classes which are used to create a script through which the business application is controlled using the API.

16. The ERP application test system of claim 15, wherein the sets of classes comprise a set of user interface classes configured to wrap to ERP system user interface elements through the API.

17. The ERP application test system of claim 16, wherein the set of user interface classes comprises a control class configured to wrap to ERP system user interface controls through the API.

18. The ERP application test system of claim 16, wherein the set of user interface classes comprises a form class, wherein an instance of the form class contains a plurality of variables for controls on a corresponding ERP system form.

19. The ERP application test system of claim 15, wherein the sets of classes comprise a set of data classes which handle data while testing logic of the business application.
